(19) United States
(12) Patent Application Publication
(10) Pub. No.: US 2025/0314996 A1
(43) Pub. Date: Oct. 9, 2025

(54) IMAGE-FORMING APPARATUS AND FOIL PRINTING SYSTEM

(71) Applicant: CANON KABUSHIKI KAISHA, Tokyo (JP)

(72) Inventors: Kenichiro Kitajima, Ibaraki (JP); Shuhei Yasuda, Chiba (JP); Tohru Nakaegawa, Chiba (JP); Shingo Hirota, Ibaraki (JP); Shuichi Tamura, Ibaraki (JP); Ryohei Terada, Chiba (JP); Daisuke Katayama, Chiba (JP); Kota Kurokawa, Chiba (JP)

(21) Appl. No.: 19/090,920

(22) Filed: Mar. 26, 2025

(30) Foreign Application Priority Data
Apr. 3, 2024 (JP) 2024-060399

(51) Int. Cl. G03G 15/00; G06K 15/00; G06K 15/02; G06T 7/00

(52) U.S. Cl. CPC G03G 15/5016; G03G 15/6585; G06K 15/005; G06K 15/1857; G06K 15/1872; G06K 15/1882; G06K 15/404; G06T 7/0004; G03G 2215/00835; G06T 2207/30144

(57) ABSTRACT

There is provided an image-forming apparatus including: an image-forming unit configured to form a toner image on a sheet based on image data; a setting unit configured to set a first mode to form the toner image for gluing a foil onto the sheet via the toner image; and a control unit configured to control a display unit to display an alert depending on a shape of the toner image to be formed by the image-forming unit in a case where the first mode is set by the setting unit.

### BACKGROUND OF THE INVENTION

### Field of the Invention

The present invention relates to an image-forming apparatus and a foil printing system.

### Description of the Related Art

Conventionally, in order to provide a print material with a metallic feel or gloss, which are difficult to be represented on a general printer, characters or pictures made of a metal foil are transferred to a sheet. Selective foil gluing through, for example, stamping using a mold, masking, and irradiation of an ultraviolet (UV) curable adhesive with UV has been known as a method of transferring a foil to a sheet.

Japanese Patent Laid-Open No. 2017-156723 and Japanese Patent Laid-Open No. 2021-116185 disclose a method in which toner of a toner image formed on a sheet is used as an adhesive for gluing a foil to the sheet. According to such a method, a toner image can be formed by application of a configuration of a general printer based on an electrophotographic method, and accordingly, a print material of a foil image with a high degree of freedom can be created in a relatively easy manner. A foil printing apparatus of Japanese Patent Laid-Open No. 2017-156723 includes a fan that blows air against the location of gluing between a sheet and a foil film to increase the detachability of a foil image from the foil film. A foil printing apparatus of Japanese Patent Laid-Open No. 2021-116185 is integrated with an image-forming apparatus that forms a normal full-color toner image, and can use only toner of a specific color as an adhesive for gluing a foil.

### SUMMARY OF THE INVENTION

However, in a case where a foil is glued onto a sheet via a toner image, there is a risk of degradation in the quality of a foil image depending on the toner image formed on the sheet.

In view of the foregoing issue, the present invention provides a mechanism to reduce the possibility of degradation in the quality of a foil image.

According to an aspect, there is provided an image-forming apparatus including: an image-forming unit configured to form a toner image on a sheet based on image data; a setting unit configured to set a first mode to form the toner image for gluing a foil onto the sheet via the toner image; and a control unit configured to control a display unit to display an alert depending on a shape of the toner image to be formed by the image-forming unit in a case where the first mode is set by the setting unit.

Further features of the present invention will become apparent from the following description of exemplary embodiments (with reference to the attached drawings).

### BRIEF DESCRIPTION OF THE DRAWINGS

FIG. 1 is a schematic configuration diagram showing an example of a configuration of a foil printing system according to an embodiment.

FIG. 2 is an explanatory diagram showing an example of a configuration of a foil.

FIG. 3 is an explanatory diagram showing how a foil is printed on a sheet.

FIG. 4A is a first explanatory diagram showing how a gluing portion of a foil becomes separated from non-gluing portions.

FIG. 4B is a second explanatory diagram showing how a gluing portion of a foil becomes separated from a non-gluing portion.

FIG. 5A is an explanatory diagram related to degradation in the quality of a foil image attributed to a shortage of glue width.

FIG. 5B is an explanatory diagram related to degradation in the quality of a foil image attributed to a shortage of gap width.

FIG. 6 is a further explanatory diagram related to degradation in the quality associated with a thin line in a toner image.

FIG. 7 is a block diagram showing an example of a configuration of an image-forming apparatus according to an embodiment in relation to a functional aspect.

FIG. 8 is a block diagram showing an example of a configuration of a foil printing apparatus according to an embodiment in relation to a functional aspect.

FIG. 9 is a block diagram showing an example of a detailed configuration of processing that can be executed for an alert related to a thin line in a first practical example.

FIG. 10 is a first explanatory diagram showing an example of a configuration of a print setting screen according to the first practical example.

FIG. 11 is a second explanatory diagram showing an example of a configuration of a print setting screen according to the first practical example.

FIG. 12 is an explanatory diagram showing an example of a configuration of an alert setting screen according to the first practical example.

FIG. 13 is an explanatory diagram showing an example of a configuration of an alert screen according to the first practical example.

FIG. 14 is a flowchart showing an example of a flow of print control processing according to the first practical example.

FIG. 15 is an explanatory diagram showing an example of how pixels at both sides of a thin line region are punctured.

FIG. 16 is an explanatory diagram showing an example of a configuration of a print setting screen according to a second practical example.

FIG. 17 is an explanatory diagram showing an example of a configuration of a correction setting screen according to the second practical example.

FIG. 18 is an explanatory diagram showing an example of a configuration of an alert screen according to the second practical example.

FIG. 19 is a flowchart showing an example of a flow of print control processing according to the second practical example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. Overview of System

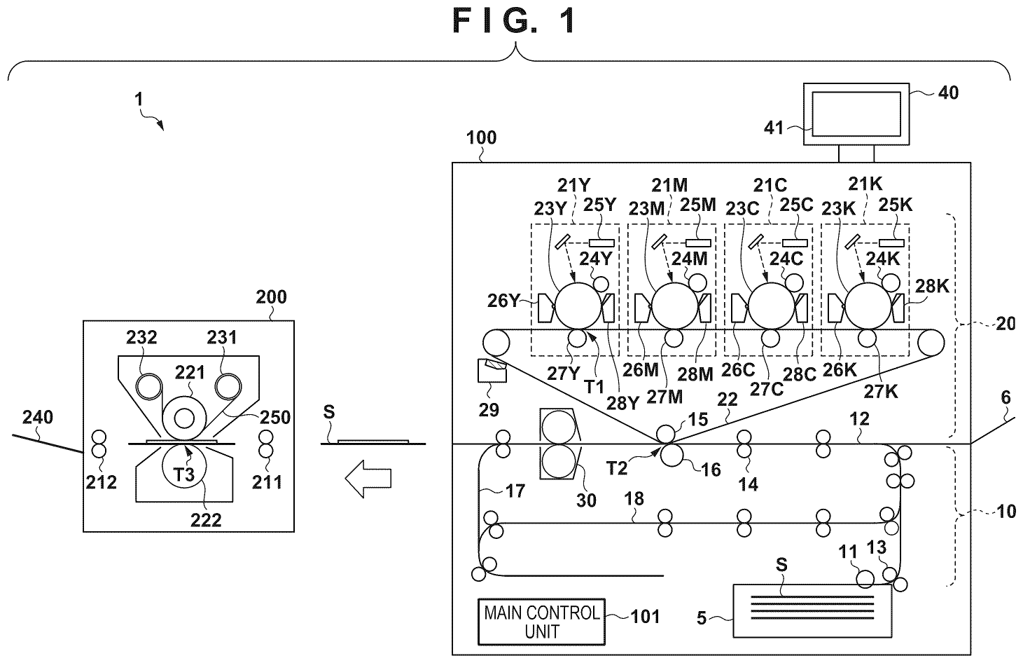

As shown in FIG. 1, a foil printing system 1 includes an image-forming apparatus 100 and a foil printing apparatus 200. The image-forming apparatus 100 forms a toner image on a sheet (also referred to as a recording material). The foil printing apparatus 200 prints a foil on the sheet by using toner of the toner image as an adhesive. In other words, the foil printing apparatus 200 glues the foil onto the sheet via the toner image.

In the present embodiment, the foil printing system 1 is a so-called offline system in which the foil printing apparatus 200 is not mechanically joined to the image-forming apparatus 100. In this case, a sheet S on which a toner image has been formed is discharged from the image-forming apparatus 100, and then manually input to the foil printing apparatus 200 by a user (see an arrow in the figure). In another embodiment, an inline system in which the foil printing apparatus 200 is joined to the image-forming apparatus 100 may be provided. In this case, the sheet S is automatically passed from the image-forming apparatus 100 to the foil printing apparatus 200. In still another embodiment, an integrated printing apparatus obtained by incorporating the foil printing function of the foil printing apparatus 200 in the interior of the image-forming apparatus 100 may be provided.

### 1-1. Exemplary Configuration of Image-Forming Apparatus

The image-forming apparatus 100 may be a color printer or a monochrome printer. In the example of FIG. 1, the image-forming apparatus 100 is a full-color tandem printer capable of forming a full-color image using an electrophotographic method. The image-forming apparatus 100 includes a cassette 5, a manual feed tray 6, a conveyance unit 10, an image-forming unit 20, a fixing unit 30, an operation unit 40, and a main control unit 101.

The image-forming unit 20 is an image-forming unit that includes process units 21Y, 21M, 21C, and 21K, an intermediate transfer belt 22, and a belt cleaner 29. The process units 21Y, 21M, 21C, and 21K are placed in parallel along the moving direction of the intermediate transfer belt 22, and form toner images in yellow, magenta, cyan, and black, respectively. Note that the letters Y, M, C, and K added at the end of reference signs in FIG. 1 may be omitted in an explanation of matters that are common to the four colors. The intermediate transfer belt 22 rotates while being hung in a stretched state around a plurality of rollers. As will be described below, toner images of four color components are transferred to the intermediate transfer belt 22 while overlapping one another (primary transfer); as a result, a full-color toner image is formed. The intermediate transfer belt 22 carries this full-color toner image and conveys the same to a secondary-transfer position T2.

The cassette 5 is a container unit for containing a bundle of sheets. Although FIG. 1 shows an example in which the image-forming apparatus 100 includes only one cassette 5, the image-forming apparatus 100 may include a plurality of cassettes 5 capable of containing sheets of different types (e.g., sizes, thicknesses, or presence/absence of surface coating). In this case, sheets of a type designated by each job are fed from a corresponding cassette 5. Note that sheets may be fed from the manual feed tray 6 rather than the cassette 5. Furthermore, the foil printing system 1 may include a paper feeding apparatus (not shown) separate from the image-forming apparatus 100.

The conveyance unit 10 includes a conveyance path and a plurality of rollers. A feed roller 11 feeds sheets, one by one, to a conveyance path 12 from the bundle of sheets inside the cassette 5. A conveyance roller 13 conveys a sheet along the conveyance path 12. A registration roller 14 sends the sheet to the secondary-transfer position T2 in synchronization with a timing at which the toner image on the intermediate transfer belt 22 reaches the secondary-transfer position T2.

As the process units 21Y, 21M, 21C, and 21K may be configured similarly to one another, they are referred to as process units 21. The process unit 21 includes a photosensitive drum 23, a charger 24, an exposure device 25, a developing device 26, a primary-transfer roller 27, and a drum cleaner 28. The photosensitive drum 23 is an image carrier having a shape of a hollow cylinder, and rotates counterclockwise in the figure. The charger 24 may be a corona charger that emits, for example, charged particles through corona discharge, and charges the surface of the photosensitive drum 23 to a uniform potential (e.g., negative-polarity dark space potential). The charger 24 may include a roller or a wire for charging. The exposure device 25 includes, for example, a semiconductor laser as a light source, and forms an electrostatic latent image on the surface of the photosensitive drum 23 by scanning the surface of the photosensitive drum 23 with laser light in accordance with input image data. The developing device 26 stores therein, for example, a developer agent composed of toner and carrier, and develops the electrostatic latent image on the surface of the photosensitive drum 23 to form a toner image by supplying the developer agent to the photosensitive drum 23.

As one example, the developer agent may be a two-component developer agent including non-magnetic toner and magnetic carrier. The toner can include a binder resin, a coloring agent, and a mold release agent (wax).

The primary-transfer roller 27 is disposed at a primary-transfer position T1 so as to oppose the photosensitive drum 23. The primary-transfer roller 27 transfers the toner image on the surface of the photosensitive drum 23 to the intermediate transfer belt 22 when primary-transfer biasing, which is a high voltage, has been applied thereto. The drum cleaner 28 removes toner remaining on the surface of the photosensitive drum 23 after the primary transfer.

The yellow, magenta, cyan, and black toner images that have been formed respectively by the process units 21Y, 21M, 21C, and 21K are transferred in sequence onto the intermediate transfer belt 22 in such a manner that they overlap one another; as a result, a full-color toner image including four color components is formed.

An outer secondary-transfer roller 16 is disposed at the secondary-transfer position T2 so as to oppose an inner secondary-transfer roller 15, which is one of the rollers around which the intermediate transfer belt 22 is hung in a stretched state. The outer secondary-transfer roller 16 transfers the full-color toner image carried by the intermediate transfer belt 22 to a sheet that has reached the secondary-transfer position T2 (secondary transfer) when secondary-transfer biasing, which is a high voltage, has been applied thereto. The belt cleaner 29 removes toner remaining on the intermediate transfer belt 22 after the secondary transfer.

The fixing unit 30 is disposed downstream relative to the secondary-transfer position T2. The fixing unit 30 includes a fixing roller (or a heat application film having a shape of a hollow cylinder) and a pressurizing roller, and applies heat and pressure to the sheet to which the toner image has been transferred, thereby fixing the toner image on the sheet. The sheet that has passed through the fixing unit 30 is discharged to the outside of the image-forming apparatus 100 (e.g., to a discharge tray (not shown)).

In a case where double-sided printing is performed, the sheet with the toner image formed on a first side thereof is conveyed to a conveyance path 17. After the travelling direction of the sheet is reversed, the sheet passes through a double-sided conveyance path 18, and returns to the conveyance path 12 in a state where the front and back thereof have been inverted. Then, a toner image is transferred to a second side of the sheet at the secondary-transfer position T2. The fixing unit 30 applies heat and pressure to the sheet again, thereby fixing the toner image on the second side of the sheet. Then, the sheet is discharged to the outside of the image-forming apparatus 100.

The operation unit 40 is a unit for providing user interfaces to a user of the foil printing system 1. The operation unit 40 includes, for example, a touch panel (display unit) 41. In accordance with control performed by the main control unit 101, which will be described below, the touch panel 41 displays images and information, and also accepts touch inputs from the user. The operation unit 40 may include output apparatuses (e.g., a liquid crystal display and a speaker) and input apparatuses (e.g., buttons, switches, a keypad, and a microphone) in place of (or in addition to) the touch panel 41.

The main control unit 101 is a control unit for controlling the overall operations of the image-forming apparatus 100. For example, when instructed to execute a print job, the main control unit 101 controls the image-forming unit 20 so as to form an image on a sheet on the basis of input image data received from an external apparatus. The external apparatus mentioned here may be, for example, a personal computer (PC) or an external controller. The image-forming apparatus 100 may further include a scanner unit (a document reading unit), although not illustrated in FIG. 1. That is to say, the image-forming apparatus 100 may be a multi-functional peripheral. In this example, when instructed to execute a copy job, the main control unit 101 controls the image-forming unit 20 so as to form an image on a sheet on the basis of read image data, which is generated by a scanner unit reading a document.

### 1-2. Exemplary Configuration of Foil Printing Apparatus

The foil printing apparatus 200 includes a conveyance roller 211, a discharge roller 212, a heating roller 221, a pressurizing roller 222, a supply reel 231, a collecting reel 232, and a discharge tray 240.

The conveyance roller 211 takes in a sheet S on which a toner image has been formed, and sends the sheet S to a gluing position T3. The heating roller 221 and the pressurizing roller 222 are disposed at the gluing position T3 so as to oppose each other. A foil 250 is wound around the supply reel 231. The collecting reel 232 holds the leading edge of the foil 250 in place. The foil 250 is suspended from the supply reel 231 and the collecting reel 232 via a bottom surface of the heating roller 221 while the reels maintain predetermined tension so as to prevent wrinkles from being formed in the foil 250. The foil printing apparatus 200 may include a further suspension roller for stably maintaining the tension of the foil 250, although not illustrated in FIG. 1.

The supply reel 231 rotates clockwise in the figure, and supplies the foil 250 to the gluing position T3. The heating roller 221 applies heat to the sheet S that has reached the gluing position T3. As a result, out of the toner composing the toner image, at least one type of toner used as an adhesive is melted. Together with the heating roller 221, the pressurizing roller 222 causes the foil 250 to come into contact with the sheet S under pressure, thereby causing the foil in an area where the toner has been melted to be glued onto the sheet S. The collecting reel 232 rotates counterclockwise in the figure, and takes up the foil 250. At this time, a part of the foil 250 that has been glued onto the sheet S is detached from the remaining part, and forms a foil image on the sheet S. The discharge roller 212 discharges the sheet S that has passed through the gluing position T3 to the discharge tray 240.

### 1-3. Exemplary Configuration of Foil

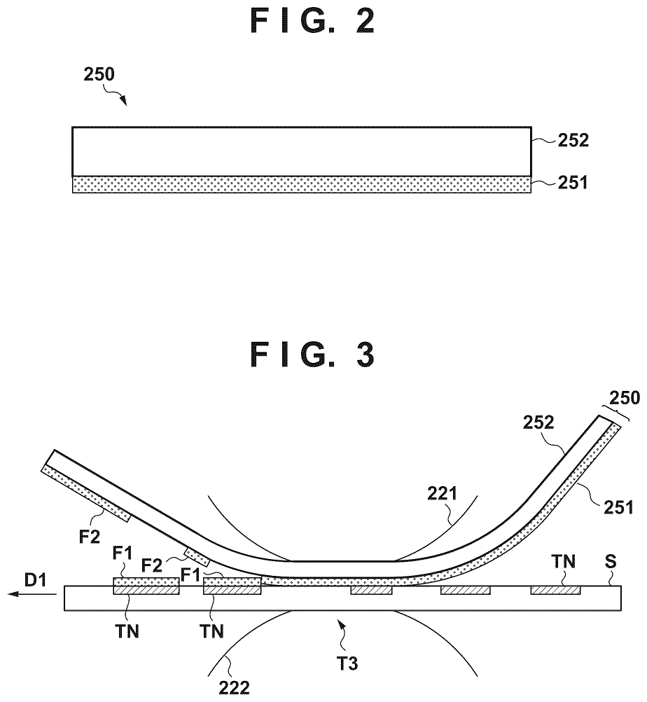

FIG. 2 shows an example of a configuration of the foil 250. The foil 250 includes a foil layer 251 and a backup layer 252. The foil layer 251 is a sheet-like layer made of a metallic material. The metallic material of the foil layer 251 may be, for example, aluminum, tin, silver, copper, chromium, nickel, gold, or iron, or an alloy of two or more of these (e.g., nickel chromium steel, bronze, or aluminum bronze). The backup layer 252 is a sheet-like layer that is made of resin and supports the foil layer 251. The resin material of the backup layer 252 may be, for example, polyethylene terephthalate (PET), polyethylene naphthalate (PEN), polypropylene (PP), polyethersulfone (PES), or polyimide (PI).

### 1-4. Formation of Foil Image

FIG. 3 is an enlarged view of a state near the gluing position T3 in the midst of an operation of the foil printing apparatus 200. In the example of FIG. 3, a sheet S on which toner images TN have been formed and the foil 250 are held between the heating roller 221 and the pressurizing roller 222, which are located above and below the gluing position T3, respectively. The heating roller 221 and the pressurizing roller 222 rotate in conjunction with the rotation of the collecting reel 232 driven by a motor (not shown), and conveys the sheet S and the foil 250 in a conveyance direction D1.

The surface temperature of the heating roller 221 is controlled so that the temperature of the toner of the toner images TN reaches a melting point. When the temperature of the toner has reached the melting point at the gluing position T3, the toner that has increased in viscosity as a result of melting acts as an adhesive, and the toner images TN are further pressurized by the pressurizing roller 222 and glued onto the foil layer 251 of the foil 250. Therefore, once the sheet S and the foil 250 have passed through the gluing position T3, portions F1 of the foil layer 251 that are in contact with the toner images TN (gluing portions) are detached from the backup layer 252 of the foil 250 in a state where they are glued onto the sheet S. On the other hand, portions F2 of the foil layer 251 that are not in contact with the toner images TN (non-gluing portions) are not glued onto the sheet S and are collected by the collecting reel 232 in a state where they remain on the backup layer 252. As a result, the foil layer 251 is selectively transferred to the sheet S in accordance with the pattern of the toner images TN on the sheet S, and forms a foil image on the sheet S.

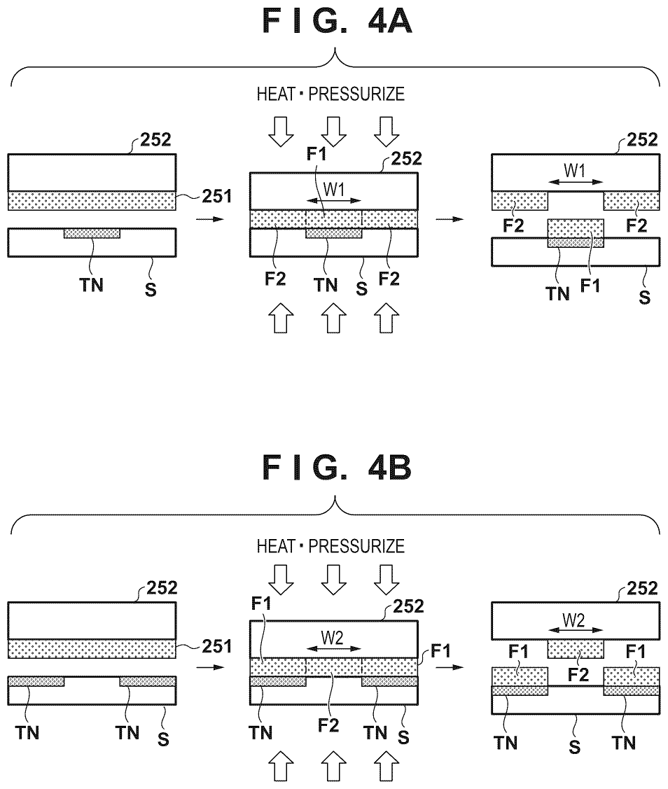

FIG. 4A and FIG. 4B further show how a gluing portion F1 of the foil layer 251 is separated from non-gluing portions F2.

In the example of FIG. 4A, a character or a thin line composing a partial toner image TN is formed at the center of the sheet S. The left side of the figure shows a state before the sheet S reaches the gluing position T3. Once the sheet S has reached the gluing position T3 (the center of the figure), the toner of the toner image TN is melted, and glued onto the foil layer 251 by being pressurized by the pressurizing roller 222. As a result, the pattern of a gluing portion F1 that is in contact with the toner image TN is latently formed in the foil layer 251; however, at this point, the gluing portion F1 has not been separated from non-gluing portions F2. A width W1 of the gluing portion F1 is equal to a width of a portion where the adhesive exists (an adhesive width). Once the sheet S and the foil 250 have passed through the gluing position T3 (the right side of the figure), the gluing portion F1 is pulled toward the sheet S side by the adhesive force of the adhesive, whereas the non-gluing portions F2 try to remain on the backup layer 252 due to the tension of the foil 250. Consequently, the gluing portion F1 and the non-gluing portions F2 are torn apart at their boundaries, and the gluing portion F1 is separated from the non-gluing portions F2 and transferred to the sheet S. In a case where the adhesive width W1 is sufficiently large and the adhesive force for separation of the gluing portion F1 from the non-gluing portions F2 is secured, a pattern similar to the toner image TN is reproduced by a foil image transferred to the sheet S.

In the example of FIG. 4B, there is a gap between toner images TN at the center of the sheet S. This gap can be, for example, an unfilled portion of an outlined letter. Once the sheet S has reached the gluing position T3, the toner of the toner images TN is melted, and glued onto the foil layer 251 by being pressurized by the pressurizing roller 222. In this way, the pattern of gluing portions F1 that are in contact with the toner images TN are latently formed in the foil layer 251. A width W2 of a non-gluing portion F2 in the figure is equal to a width of the gap where no glue exists (a gap width). Once the sheet S and the foil 250 have passed through the gluing position T3, the gluing portions F1 are separated from the non-gluing portion F2 and transferred to the sheet S, similarly to the example of FIG. 4A. In a case where the gap width W2 is sufficiently large and the tension for the non-gluing portion F2 to remain on the backup layer 252 is secured, an outlined pattern similar to the pattern represented by the toner images TN is reproduced by a foil image on the sheet S.

### 1-5. Degradation in Quality Related to Thin Line

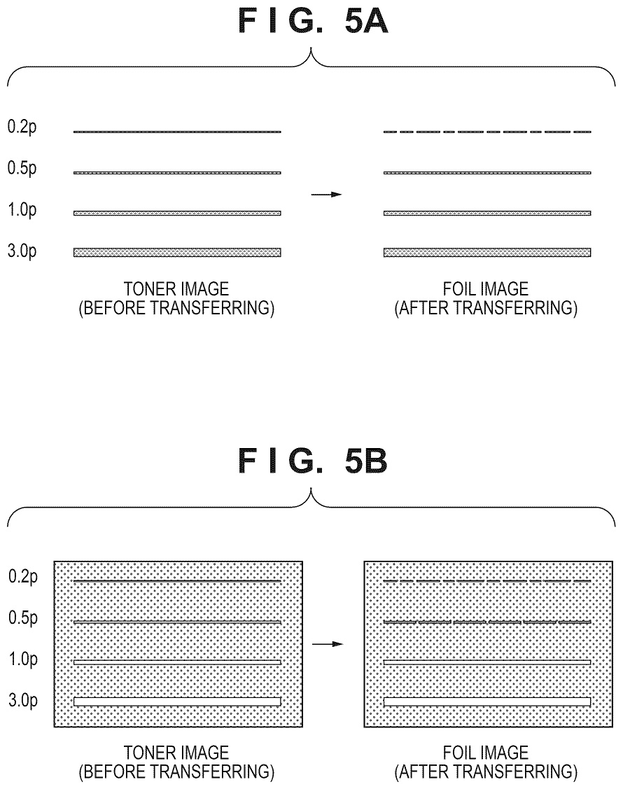

FIG. 5A is an explanatory diagram related to degradation in the quality of a foil image attributed to a shortage of glue width W1. The left side of the figure illustrates four straight lines that can be included in a toner image; the line widths of these straight lines are 0.2 points (p), 0.5 p, 1.0 p, and 3.0 p from the top, respectively. Note that 1 p is equal to approximately 0.35 mm. When the foil has been transferred to this toner image, a part of the straight lines can be lost as shown in the right side of the figure. The loss occurs in straight lines with a line width smaller than a certain limit value. In the example shown, the straight line of 0.2 p is disconnected at many positions.

FIG. 5B is an explanatory diagram related to degradation in the quality of a foil image attributed to a shortage of gap width W2. The left side of the figure illustrates four outlined straight lines that can be included in a toner image; the line widths of these straight lines are 0.2 p, 0.5 p, 1.0 p, and 3.0 p from the top, respectively. When the foil has been transferred to this toner image, a part of the straight lines can break as shown in the right side of the figure. The breakage occurs in straight lines with an unfilled width smaller than a certain limit value.

In the example shown, the straight lines of 0.2 p and 0.5 p break at several positions. Comparing FIG. 5A and FIG. 5B, it is apparent that the limit value for line widths in an outlined image is larger than the limit value for line widths in a normal image, that is to say, degradation in the quality is triggered more easily in the outlined image, even for a larger line width.

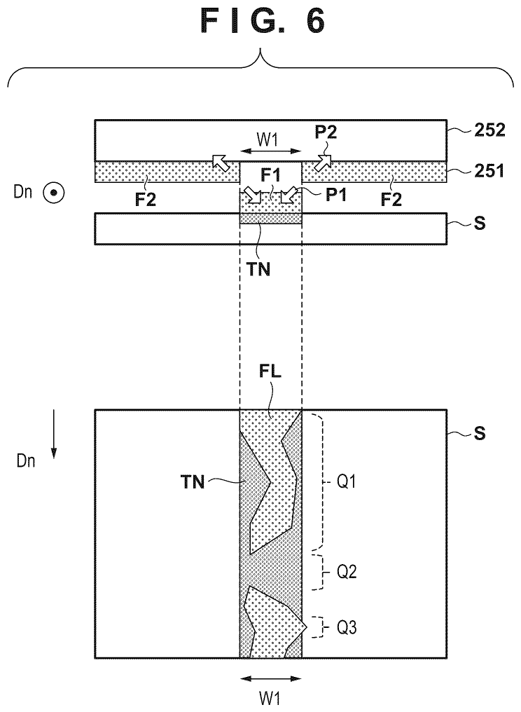

FIG. 6 is a further explanatory diagram related to degradation in the quality associated with a thin line in a toner image. The upper side of FIG. 6 shows a state where the sheet S and the foil 250 that have already passed through the gluing position T3 are viewed along a direction of extension Dn of a straight line included in a toner image TN. It is assumed that the adhesive width W1 of the toner image TN is equal to the line width of this straight line, but is smaller than the limit value at which degradation in the quality of the foil image starts to appear (e.g., W1=0.2 p). It appears that a gluing portion F1 is glued onto the toner image TN, and the gluing portion F1 has been separated from the foil 250.

The lower side of FIG. 6 shows a state where this sheet S is viewed along a direction of the normal to the sheet surface. In the example shown, the outline of the foil image transferred to the toner image TN does not match the outline of the straight line in the toner image TN. In section Q1, parts of the foil have not been transferred to the sheet S at both sides of the straight line, and the outline of the foil image is irregular. In section Q2, there is no foil, and the line of the foil image is disconnected. In section Q3, the outline of the foil image is still irregular, and a part thereof protrudes from the straight line.

It is considered that the cause of such irregularity, disconnection, or protrusion is disproportion or variation in tensile forces acting on the gluing portion F1 and non-gluing portions F2 when the gluing portion F1 tries to be detached from the foil 250. For example, in a case where the adhesive width W1 is small, a gluing area of the gluing portion F1 relative to the toner image TN becomes small, and accordingly, a tensile force P1 that pulls the gluing portion F1 toward the sheet side also becomes small. As a result, variation in the tensile forces becomes relatively dominant, and the positions of balance with a tensile force P2 in the reverse direction, which tries to make the non-gluing portions F2 remain on the backup layer 252, become erratic in the surface direction of the foil. This can cause irregularity and protrusion. Alternatively, if the tensile force P1 that pulls the gluing portion F1 toward the sheet side cannot overcome the tensile force P2 in the reverse direction, the gluing portion F1 is not glued to the toner image TN, and the gluing portion F1 remains on the backup layer 252. This can cause disconnection.

In an outlined image, in a case where the gap width W2 is small, a tensile force that tries to cause a non-gluing portion F2 located in a gap between glues to remain on the backup layer 252 becomes small. As a result, the positions of balance with a tensile force in the reverse direction, which tries to pull gluing portions F1 toward the sheet side, become erratic in the surface direction of the foil. If the former tensile force cannot overcome the latter tensile force, the non-gluing portion F2 is detached from the backup layer 252 and transferred to the sheet S, together with the gluing portions F1 at both sides thereof. This can cause breakage.

Tensile forces acting on a gluing portion F1 and a non-gluing portion F2 are also dependent on a direction of a boundary line therebetween. For example, the directions and magnitudes of the tensile forces can vary among a case where the direction of the boundary line is parallel to the conveyance direction of the sheet S, a case where the direction of the boundary line is perpendicular to the conveyance direction, and other cases. In addition, irregularity of outlines of a line included in the toner image TN, unevenness in the amount of applied toner (coating thickness), puncturing of dots during image formation, and the like also bring about variation in the tensile forces, and can be the cause of irregularity, disconnection, protrusion, or breakage of a thin line in the foil image.

In a case where the toner of the toner image is expected to be used as an adhesive, the above-described degradation in the quality of the foil image can be prevented by sufficiently securing a line width in the toner image. If the line width (e.g., the adhesive width or the gap width) is sufficiently large, the influence of variation in the tensile forces becomes relatively small in relation to the magnitudes of the tensile forces. As a result, the positions of balance between the tensile forces can become less erratic, irregularity and protrusion of a line in the foil image can be reduced, and disconnection and breakage can be prevented.

In view of the above, in a case where toner of a toner image formed by the image-forming apparatus 100 is used as an adhesive, the foil printing system 1 determines a possibility that a thin line in the toner image causes degradation in the quality, and alerts the user depending on the result of this determination.

### 2. Details of Functions

### 2-1. Exemplary Functional Configuration of Image-Forming Apparatus

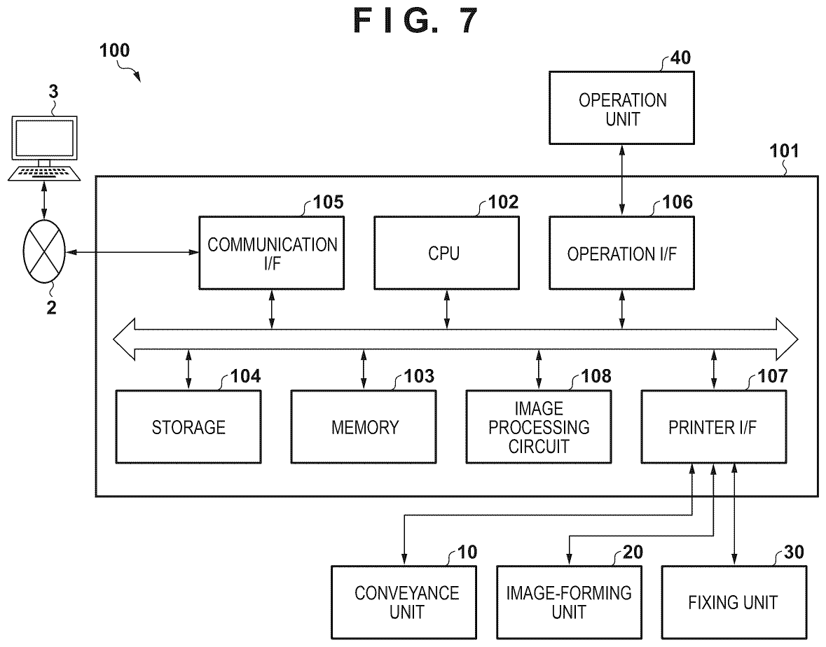

FIG. 7 shows an example of a configuration of the image-forming apparatus 100 according to an embodiment in relation to a functional aspect. Referring to FIG. 7, the main control unit 101 of the image-forming apparatus 100 includes a CPU 102, a memory 103, a storage 104, a communication interface (I/F) 105, an operation I/F 106, a printer I/F 107, and an image processing circuit 108.

The central processing unit (CPU) 102 controls various functions of the image-forming apparatus 100. For example, in a case where an instruction for executing an image-forming job (a print job or a copy job) has been issued, the CPU 102 controls the conveyance unit 10, the image-forming unit 20, and the fixing unit 30 so as to form a toner image on a sheet on the basis of image data processed by the image processing circuit 108. Furthermore, in the present embodiment, the CPU 102 controls an alert to the user related to a thin line in a case where toner is used as an adhesive. The alert related to the thin line will be described below in detail.

The memory 103 is a storage unit that can include, for example, a random-access memory (RAM) and a read-only memory (ROM). The storage 104 is a large-capacity storage unit, such as a hard disk drive (HDD) and a solid-state drive (SSD). The memory 103 and the storage 104 can store a computer programs executed by the CPU 102, and various types of data, such as below-described setting data and image data.

The communication I/F 105 is an interface intended for the image-forming apparatus 100 to communicate with another apparatus. In the example of FIG. 7, the communication I/F 105 is connected to an external apparatus 3 (e.g., a PC) via a network 2. The network 2 may be a wired network or a wireless network. Note that the image-forming apparatus 100 may be connected to the external apparatus via some sort of communication cable in place of the network 2.

The operation I/F 106 is an interface for connecting the operation unit 40 to the main control unit 101. The CPU 102 can obtain user inputs accepted by the operation unit 40 via the operation I/F 106. Furthermore, the CPU 102 can display images on the touch panel 41 of the operation unit 40 by outputting image signals to the operation unit 40 via the operation I/F 106.

The printer I/F 107 is an interface that mediates communication between the CPU 102 and the conveyance unit 10, image-forming unit 20, and fixing unit 30. For example, the CPU 102 controls a conveyance speed and a conveyance timing of a sheet in the conveyance unit 10, controls image-forming conditions in the image-forming unit 20, and controls a fixing temperature in the fixing unit 30.

In the present embodiment, the CPU 102 sets an operation mode related to formation of a toner image on the image-forming apparatus 100. Typically, the CPU 102 causes the user to select one of a plurality of operation modes, and sets the selected operation mode. Then, the CPU 102 controls the execution of the image-forming job in the set operation mode. A first mode among the plurality of operation modes is a foil printing mode. The foil printing mode is an operation mode in which a toner image is formed in order to glue a foil onto a sheet via the toner image. The sheet having the toner image formed in the foil printing mode is input to the foil printing apparatus 200 after being discharged from the image-forming apparatus 100. A second mode among the plurality of operation modes is a normal mode. In the normal mode, toner of a toner image is not expected to be used as an adhesive. That is to say, a sheet having the toner image formed in the normal mode is not input to the foil printing apparatus 200 after being discharged from the image-forming apparatus 100. In the foil printing mode, the CPU 102 may control the conveyance unit 10, image-forming unit 20, and fixing unit 30 so as to form the toner image under image-forming conditions different from those in the normal mode. For example, the CPU 102 may set a target value of a fixing temperature in the fixing unit 30 in the foil printing mode at a value different from a target value in the normal mode. Note that in an embodiment in which the foil printing system 1 is an inline system, the first mode may be set automatically (without the user's selection) based on the fact that the foil printing apparatus 200 is joined to the image-forming apparatus 100.

The image processing circuit 108 converts a format of input image data of a job into a format appropriate for driving the image-forming unit 20. Typically, the input image data accepted from the external apparatus is, for example, page description language (PDL) data described in PDL, such as PostScript (PS) or printer command language (PCL). For example, a color space of the PDL data is an RGB space (or grayscale), and has a bit depth of 8 bits. The image processing circuit 108 converts such PDL data into binary image data having color components of Y, M, C, and K, respectively. An example of a more detailed configuration of the image processing circuit 108 will be further described below.

The image data after the conversion by the image processing circuit 108 is temporarily stored into a frame memory, and output to the image-forming unit 20 when the execution of the job has been started. Based on this image data, the image-forming unit 20 forms a toner image on a sheet. For example, the exposure device 25 of each process unit 21 exposes the surface of the photosensitive drum 23 with light while turning ON/OFF the laser light in accordance with signal values indicated by image data of the corresponding color component.

### 2-2. Exemplary Functional Configuration of Foil Printing Apparatus

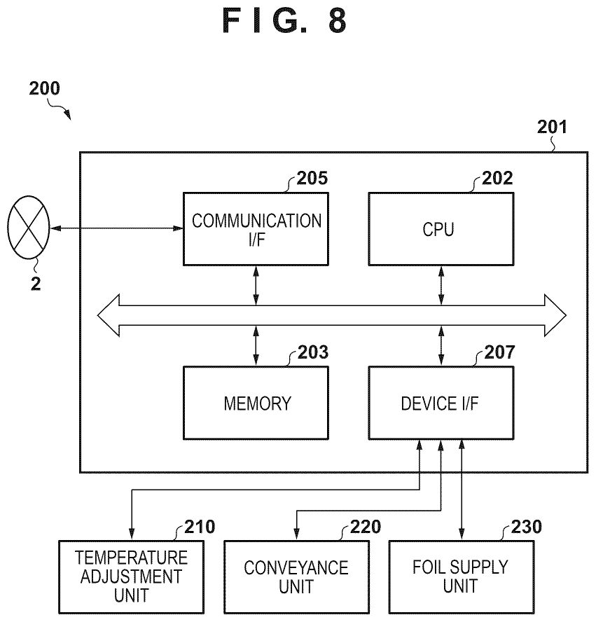

FIG. 8 shows an example of a configuration of the foil printing apparatus 200 according to an embodiment in relation to a functional aspect. Referring to FIG. 8, the foil printing apparatus 200 includes a control unit 201, a temperature adjustment unit 210, a conveyance unit 220, and a foil supply unit 230. The control unit 201 includes a CPU 202, a memory 203, a communication I/F 205, and a device I/F 207.

The CPU 202 performs control for causing a foil printing function of the foil printing apparatus 200 to work appropriately. For example, in a case where inputting of a sheet to the foil printing apparatus 200 has been detected, the CPU 202 performs control to cause a heater (not shown) of the temperature adjustment unit 210 to operate, and maintain the temperature of the heating roller 221 at a target temperature on the basis of the temperature measured by a thermistor (not shown). Also, the CPU 202 drives a motor (not shown) of the conveyance unit 220, thereby causing the conveyance roller 211 and the discharge roller 212 to rotate and conveying the sheet. Furthermore, the CPU 202 drives a motor (not shown) of the foil supply unit 230, thereby causing the collecting reel 232 to rotate and supplying the foil 250 from the supply reel 231 to the gluing position T3.

The memory 203 is a storage unit for storing a computer program executed by the CPU 202, and data. The memory 203 may be, for example, any combination of RAMs and ROMs. The communication I/F 205 is an interface intended for the foil printing apparatus 200 to communicate with another apparatus. In the example of FIG. 8, the communication I/F 205 is connected to the network 2. The device I/F 207 is an interface that mediates communication between the CPU 202 and the temperature adjustment unit 210, conveyance unit 220, and foil supply unit 230.

Although not shown in FIG. 8, the foil printing apparatus 200 may include an operation unit similar to those in the above-described operation unit 40. In this case, the CPU 202 can obtain user inputs accepted by the operation unit. Furthermore, the foil printing apparatus 200 may include a display unit capable of displaying images.

### 2-3. Alert Related to Thin Line

In the present embodiment, depending on a shape of a toner image, the image-forming apparatus 100 issues an alert for making the user aware of the possibility of degradation in the quality of foil printing. For example, alert conditions related to a thin line for a case where toner of the toner image is used as an adhesive are stored in the memory 103 or the storage 104 in advance. In a case where it is determined that the toner image formed by the image-forming unit 20 satisfies an alert condition, the main control unit 101 controls the display of the operation unit 40 or the external apparatus 3 to display the alert.

Typically, before the image-forming unit 20 forms the toner image on a sheet, the main control unit 101 determines whether the toner image satisfies an alert condition by analyzing input image data. In a case where it is determined that the toner image satisfies an alert condition, an alert is issued to the user prior to the execution of a job, and thus the user can suspend the execution of the job and modify the toner image as necessary.

For example, in a case where a specific part of the toner image satisfies an alert condition, the main control unit 101 may display a preview of the toner image on the display in a mode that allows this specific part to be distinguished.

In the present embodiment, the alert conditions include a condition that a feature amount of image data influencing the width of the thin line (hereinafter referred to as thin line feature amounts) is smaller than a threshold. The thin line feature amounts mentioned here may include at least one of the following:
Feature amount A1—a width of a line within the image
Feature amount A2—a size of a character within the image
Feature amount A3—the number of pixels aligned in a thin line region in the width direction thereof within the image (hereinafter referred to as a thin line region width)

The feature amounts A1 and A2 are typically obtained by extracting attributes of constituent elements of the image from the image data described in a PDL format. A first threshold compared with a width of a line (feature amount A1) may be, for example, 1.0 point. In this case, the main control unit 101 determines that an alert condition is satisfied when the image includes a thin line with a width smaller than 1.0 point. A second threshold compared with a size of a character (feature amount A2) may be, for example, 14 points. In this case, the main control unit 101 determines that an alert condition is satisfied when the image includes a character described in a character size smaller than 14 points.

The feature amount A3 is obtained by detecting the thin line region within the image represented in a bitmap format, and determining the number of pixels aligned in the detected thin line region in the width direction thereof. This detection of the thin line region may be performed using any known method, such as those described in Japanese Patent Laid-Open No. 2016-167777 and Japanese Patent Laid-Open No. 2019-139083, for example. As one example, Japanese Patent Laid-Open No. 2016-167777 discloses a method of determining whether each pixel of interest is a pixel composing a thin line by comparing a pixel value matrix within a window composed of a pixel of interest and nearby peripheral pixels with a predetermined matrix pattern representing a local thin line. The window size and the matrix pattern are determined in advance in consideration of the width of the thin line region to be detected. By repeating this determination while moving the position of the pixel of interest within the image represented in the bitmap format, pixels that belong to the thin line region and other pixels are distinguished. The thin line region width can be determined by counting the pixels aligned in the thin line region thus detected in the width direction thereof.

A third threshold compared with the thin line region width (feature amount A3) may be, for example, 10 pixels (equivalent to approximately 0.42 mm in the case of 600 dpi). In this case, the main control unit 101 determines that an alert condition is satisfied when the image includes a thin line region with a thin line region width smaller than 10 pixels.

The feature amount A3 can be, for example, used complementarily in addition to the feature amounts A1 and A2 to make a determination about the alert conditions. This is because there may be a shortage of line width due to puncturing of pixels composing the thin line region in the course of placing the image data into a bitmap and binary data for the image-forming operation. FIG. 15 shows an example of how pixels at both sides of a thin line region R1 are punctured in the course of image processing. When pixels are punctured in this way, the line width of the thin line region R1 partially decreases. As such a shortage of line width cannot be detected from the attributes described in the PDL data, it is beneficial to complementarily use the feature amount A3 and prevent a failure to detect the shortage of line width. Note that it is also possible to make determination about an alert condition only using the feature amount A3 without using the feature amounts A1 and A2.

The aforementioned specific values of the first threshold, the second threshold and the third threshold are merely examples for explanation. Naturally, other values may be used as thresholds for determining the alert conditions. The memory 103 of the main control unit 101 stores these thresholds.

Below is a more specific description of two practical examples for control that accompanies the aforementioned alert related to a thin line.

### 3. First Practical Example

### 3-1. Configuration of Processing

In the first practical example, the image processing circuit 108 analyzes input image data and extracts thin line feature amounts. The image processing circuit 108 stores feature amount data 123 indicating the extracted thin line feature amounts into the memory 103. The CPU 102 determines whether a toner image satisfies any alert condition on the basis of this feature amount data 123, and alerts the user in accordance with the result of this determination.

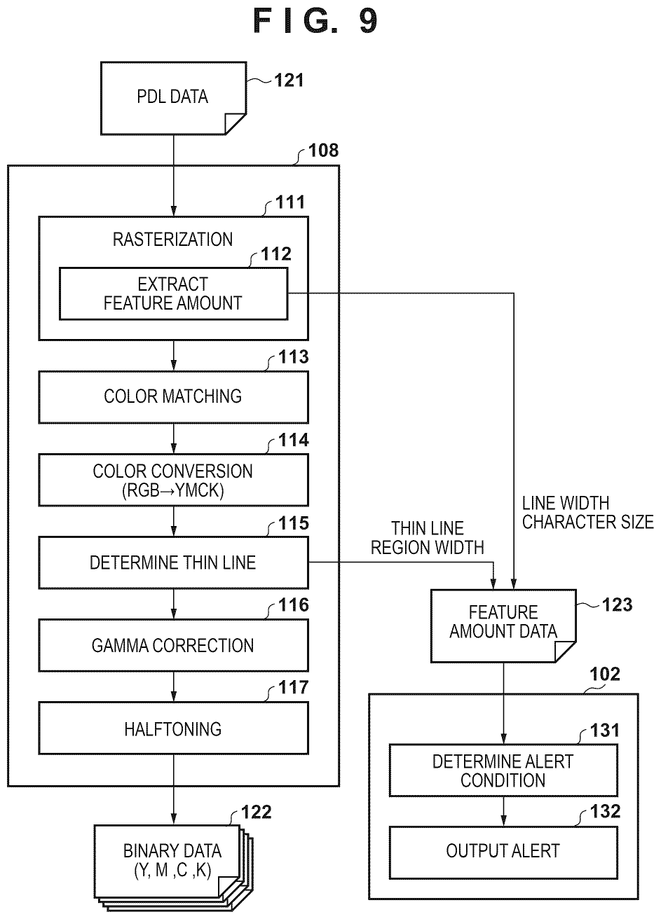

FIG. 9 shows an example of a specific configuration of processing that can be executed by the CPU 102 and the image processing circuit 108 for an alert related to a thin line in the first practical example. Referring to FIG. 9, the processing executed by the image processing circuit 108 includes rasterization 111, color matching 113, color conversion 114, thin line determination 115, gamma correction 116, and halftoning 117. Rasterization 111 includes feature amount extraction 112. The processing executed by the CPU 102 includes alert condition determination 131 and alert output 132.

Rasterization 111 is processing for interpreting an image represented by PDL data 121 at a high level in accordance with a resolution designated by a job, and converting the PDL data 121 into bitmap data pieces of three color components corresponding to R, G, and B. For example, for each object (constituent element) composing the image, the PDL data 121 specifies a position and a type of the object. Candidates for the type of the object include, for example, a line, a character, a graphic, and a photograph. A line object includes a line width as an attribute. This line width corresponds to the aforementioned feature amount A1. A character object includes a character size as an attribute. This character size corresponds to the aforementioned feature amount A2. The image processing circuit 108 extracts these feature amounts from the PDL data 121, and generates feature amount data 123. In the feature amount data 123, each feature amount is held in association with the position of the corresponding object.

Color matching 113 is processing for adjusting RGB signal values to maintain color tones in the printing result constant without being influenced by differences in the color reproducibility between devices.

Color conversion 114 is processing for converting image data represented in an RGB space into image data of a YMCK space corresponding to the developer agent (toner) of four colors.

Thin line determination 115 is processing for detecting a thin line region from bitmap data pieces of color components corresponding to Y, M, C, and K, respectively, and determining a thin line region width denoted by the number of pixels. This thin line region width corresponds to the aforementioned feature amount A3. In a case where one or more thin line regions have been detected from within the image, the image processing circuit 108 adds the thin line region widths determined for the respective thin line regions to the feature amount data 123 in association with the detection positions of these thin line regions. Note that in a case where only a part of the toner of the plurality of color components is used as an adhesive, the image processing circuit 108 may execute thin line determination 115 only with respect to the bitmap data of the color component corresponding to the toner used as the adhesive.

Gamma correction 116 is processing for correcting signal values of the respective color components with use of gamma curves that are selected in accordance with density output characteristics of the process units 21Y, 21M, 21C, and 21K.

Halftoning 117 is processing for converting tones represented by multi-valued signal values for the respective pixels into spatial area tones with use of, for example, a dither method or an error diffusion method. As a result of halftoning 117, image data 122 is generated that represents a toner image of color components corresponding to Y, M, C, and K, respectively, using a binary signal value for each pixel.

Alert condition determination 131 is processing for determining whether the toner image satisfies an alert condition(s) with use of the thin line feature amounts extracted or determined in the aforementioned image processing. In the present practical example, in a case where the foil printing mode has been set out of the foil printing mode and the normal mode, the CPU 102 executes alert condition determination 131 on the basis of the feature amount data 123. For example, the CPU 102 can determine that the toner image satisfies an alert condition(s) in a case where at least one of the feature amount A1, the feature amount A2, and the feature amount A3 includes a value smaller than the corresponding threshold. In a case where it has been determined that the toner image does not satisfy any alert condition, the CPU 102 skips alert output 132, and starts the execution of an image-forming job. On the other hand, in a case where it has been determined that the toner image satisfies at least one alert condition, the CPU 102 executes alert output 132.

Alert output 132 is processing for outputting a warning for making the user aware of a possibility that a thin line in the toner image causes degradation in the quality of foil printing. In the present practical example, the CPU 102 causes the display of the operation unit 40 or the external apparatus 3 to display a message for the alert. Note that in another practical example, the alert may be output using other methods, such as outputting of a sound, transmission of a text message, and outputting of log data. The following section will describe several examples of a user interface for such an alert.

### 3-2. Examples of User Interface (UI)

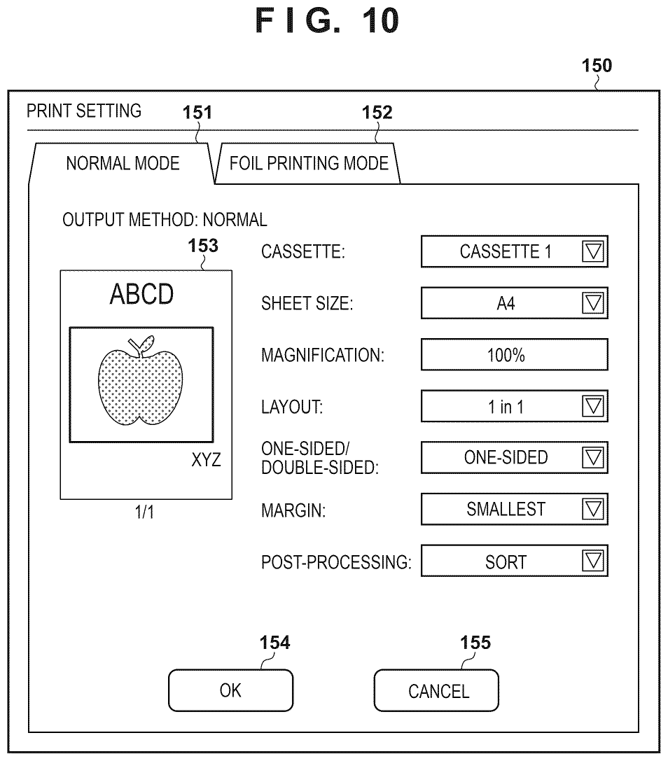

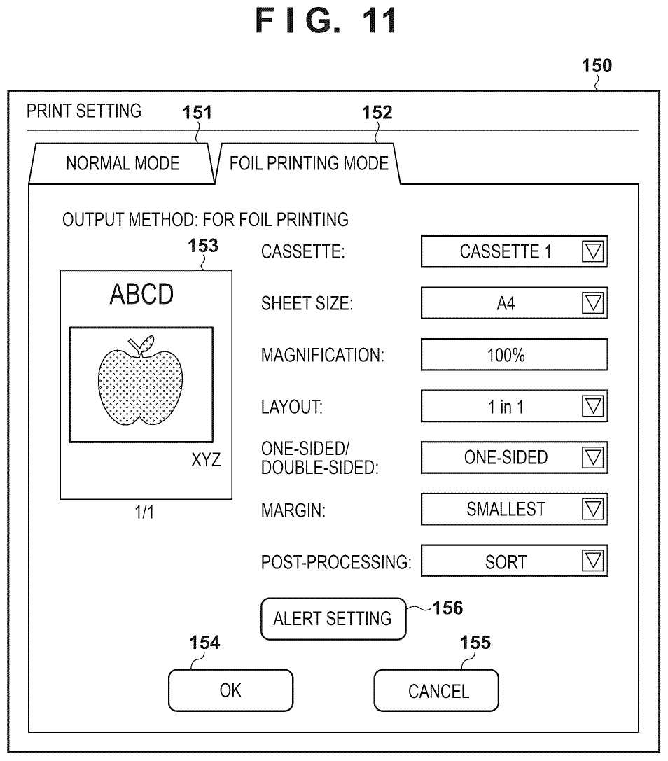

FIG. 10 and FIG. 11 show examples of a configuration of a print setting screen 150 according to the first practical example. The print setting screen 150 includes a normal mode tab 151 and a foil printing mode tab 152. When the user wishes to form an image in the normal mode, the user selects the normal mode tab 151. Also, in a case where the user is planning to print a foil on a sheet by using toner of a toner image as an adhesive, he or she selects the foil printing mode tab 152.

FIG. 10 shows an exemplary screen configuration of the normal mode tab 151. The normal mode tab 151 includes a preview window 153, several setting items, an OK button 154, and a cancel button 155. In the normal mode, the user can set such items as a cassette acting as a paper feed source, a sheet size, a magnification, a layout, one-sided/double-sided, margin, and post-processing. The preview window 153 is a window that displays a preview of the toner image to be printed in the normal mode. When the user has operated the OK button 154, the CPU 102 starts the execution of a job in the normal mode. When the user has operated the cancel button 155, the CPU 102 stops the execution of the job and closes the print setting screen 150.

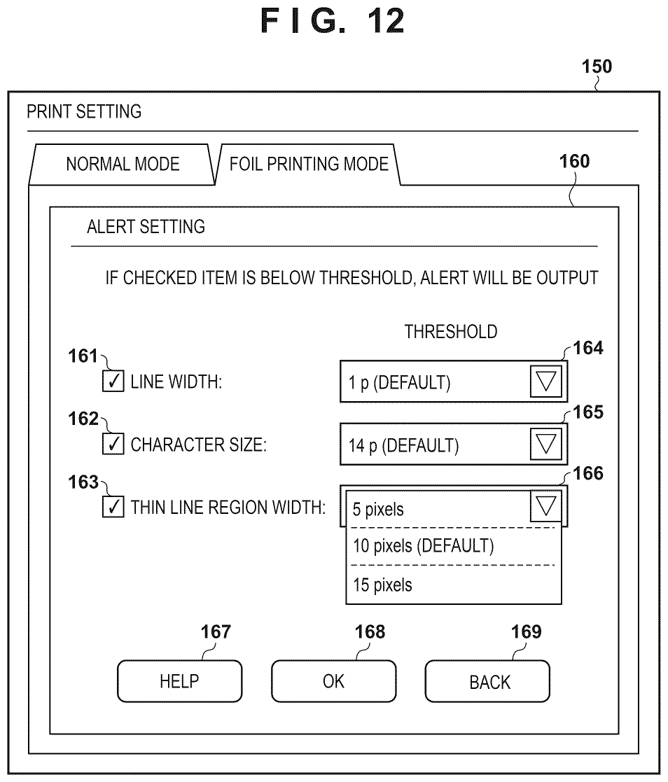

FIG. 11 shows an exemplary screen configuration of the foil printing mode tab 152. The foil printing mode tab 152 includes an alert setting button 156 in addition to screen elements similar to those on the normal mode tab 151. When the user has operated the alert setting button 156, the CPU 102 causes the display to display an alert setting screen 160 shown in FIG. 12.

FIG. 12 shows an example of a configuration of the alert setting screen 160 according to the first practical example. The alert setting screen 160 includes checkboxes 161, 162, and 163, pull-down menus 164, 165, and 166, a help button 167, an OK button 168, and a back button 169. The checkboxes 161, 162, and 163 are objects that allow the user to set whether to make a determination about the alert conditions with regard to a line width, a character size, and a thin line region width, respectively.

In a case where the user wishes to receive an alert related to a shortage of line width, the user switches the checkbox 161 ON, and selects a desired value for the first threshold in the pull-down menu 164. In a case where the user does not select a threshold, a default value related to the first threshold is used. Also, in a case where the user wishes to receive an alert related to a shortage of character size, the user switches the checkbox 162 ON, and selects a desired value for the second threshold in the pull-down menu 165. In a case where the user does not select a threshold, a default value related to the second threshold is used. Furthermore, in a case where the user wishes to receive an alert related to a shortage of thin line region width, the user switches the checkbox 163 ON, and selects a desired value for the third threshold in the pull-down menu 166. In a case where the user does not select a threshold, a default value related to the third threshold is used.

By allowing the user to set thresholds to be compared with the thin line feature amounts as in the foregoing example, the user can flexibly adjust the alert conditions in accordance with properties of the apparatus for foil printing, properties of the toner or the foil, or the extent of degradation in the quality accepted by the user.

When the user has operated the help button 167, a further screen presenting a description about each alert condition is displayed. When the user has operated the OK button 168, the CPU 102 obtains the setting contents changed on the alert setting screen 160, and stores them into the memory 103 or the storage 104. When the user has operated the back button 169, the CPU 102 discards changes of settings on the alert setting screen 160, closes the alert setting screen 160, and displays the print setting screen 150 again.

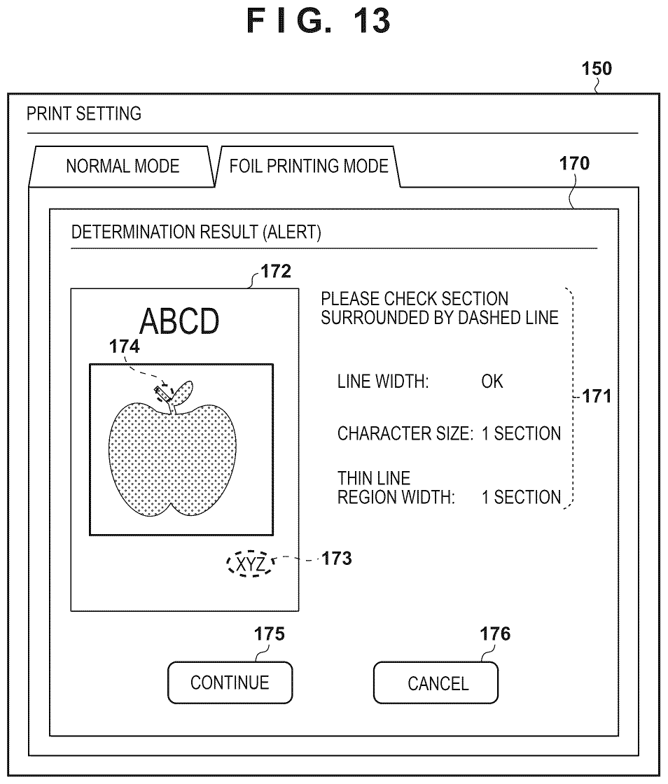

When the user has operated the OK button 154 on the foil printing mode tab 152, the CPU 102 refers to the latest alert settings, and checks whether a determination about at least one alert condition has been enabled. In a case where a determination about at least one alert condition has been enabled, the CPU 102 determines whether the toner image satisfies the alert condition(s) on the basis of the feature amount data 123 output from the image processing circuit 108. In a case where it has been determined that the toner image satisfies at least one alert condition, the CPU 102 causes the display to display an alert screen 170 shown in FIG. 13.

FIG. 13 shows an example of a configuration of the alert screen 170 according to the first practical example. The alert screen 170 includes a determination result field 171, a preview window 172, a continue button 175, and a cancel button 176. The determination result field 171 is a field that describes the result of the determination about the alert condition(s) based on input image data of the job. In the example of FIG. 13, text indicating the following is displayed: there is no section in which a line width is smaller than the threshold, but one section in which a character size is smaller than the threshold, and one section in which a thin line region width is smaller than the threshold, have been detected. The preview window 172 is a window that displays a preview of the toner image to be printed in the foil printing mode. In the example of FIG. 13, indicators 173 and 174 are superimposed on the preview window 172. The indicator 173 indicates the position of characters that satisfy the alert condition. The indicator 174 indicates the position of a thin line region that satisfies the alert condition. By looking at this preview, the user can easily be aware of which section in the input image is to be modified to avoid degradation in the quality of foil printing in the later stage. When the user has operated the continue button 175, the CPU 102 starts the execution of the job in the foil printing mode. When the user has operated the cancel button 176, the CPU 102 stops the execution of the job.

### 3-3. Flow of Processing

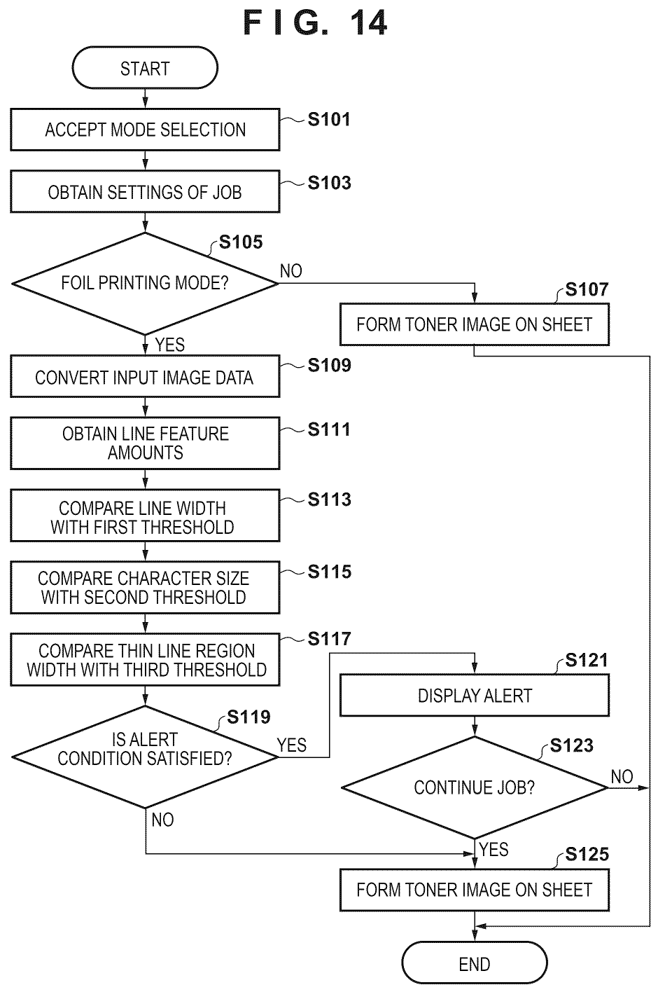

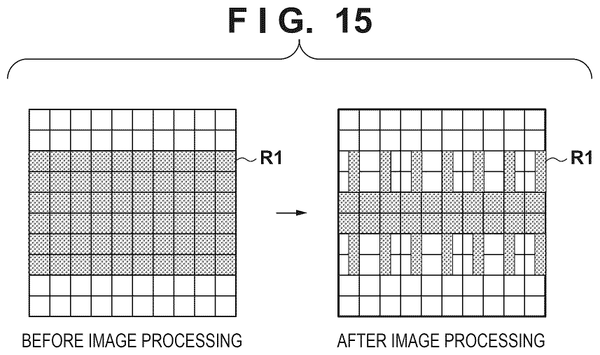

FIG. 14 is a flowchart showing an example of a flow of print control processing that can be executed by the main control unit 101 of the image-forming apparatus 100 in the present practical example. The print control processing of FIG. 14 is started in response to, for example, the user's call-up of the aforementioned print setting screen 150 via the operation unit 40 or the external apparatus 3. In the following description, processing steps will be abbreviated as “S”.

First, in step S101, the main control unit 101 accepts the user's selection of an operation mode, and sets the selected operation mode on the apparatus. Here, the normal mode or the foil printing mode is set. Next, in step S103, the main control unit 101 obtains settings of a job. For example, the main control unit 101 obtains settings related to several setting items that can be designated on the print setting screen 150. Also, in a case where the foil printing mode has been selected, the main control unit 101 obtains settings for the alert conditions that can be designated on the alert setting screen 160.

Thereafter, processing bifurcates in step S105 depending on the set operation mode. In a case where the user has selected the normal mode and issued an instruction for starting the execution of the job (step S105-NO), processing proceeds to step S107. In step S107, the main control unit 101 controls the conveyance unit 10, the image-forming unit 20, and the fixing unit 30 so as to form a toner image on a sheet in the normal mode.

In a case where the user has selected the foil printing mode and issued an instruction for starting the execution of the job (step S105-YES), processing proceeds to step S109. In step S109, the main control unit 101 converts the format of input image data from a PDL format to a binary bitmap format. Also, in step S111, the main control unit 101 obtains thin line feature amounts (e.g., a line width, a character size, and a thin line region width) of the toner image to be formed based on the input image data.

Next, in steps S113 to S117, the main control unit 101 compares the thin line feature amounts with the thresholds that have been predetermined or set by the user. For example, in a case where the determination about the alert condition related to the line width has been enabled, the main control unit 101 compares a line width extracted from the PDL data with the first threshold in step S113. Also, in a case where the determination about the alert condition related to the character size has been enabled, the main control unit 101 compares a character size extracted from the PDL data with the second threshold in step S115. Furthermore, in a case where the determination about the alert condition related to the thin line region width has been enabled, the main control unit 101 compares a thin line region width indicating a thin line width detected in bitmap data with the third threshold in step S117.

Next, in step S119, based on the result of comparison with the thresholds in steps S113 to S117, the main control unit 101 determines whether the toner image satisfies at least one alert condition. In a case where at least one alert condition is satisfied, processing proceeds to step S121. In a case where no alert condition is satisfied, processing proceeds to step S125.

In step S121, the main control unit 101 causes the display to display the aforementioned alert screen 170. Next, in step S123, the main control unit 101 accepts a user input representing an instruction on whether to continue the job on the alert screen 170. In a case where an instruction for continuing the job has been issued, processing proceeds to step S125. On the other hand, in a case where an instruction for stopping the job has been issued, the print control processing of FIG. 14 is ended without forming the toner image on a sheet.

In step S125, the main control unit 101 controls the conveyance unit 10, the image-forming unit 20, and the fixing unit 30 so as to form the toner image on a sheet in the foil printing mode. The sheet on which the toner image has been formed is discharged from the image-forming apparatus 100 after passing through the fixing unit 30. When the user has input this sheet to the foil printing apparatus 200, the foil printing apparatus 200 prints a foil on the sheet by using toner of the toner image as an adhesive.

The present section has been described mainly using an example in which a determination about the alert condition(s) is made and the user is alerted before the execution of the job is started, that is to say, before the image-forming unit 20 forms the toner image; however, the timings of the determination about the alert condition(s) and the alert are not limited to this example. For example, the main control unit 101 may determine whether the toner image satisfies the alert condition(s) in parallel with the image-forming operation. In a case where it has been determined that the toner image satisfies the alert condition(s), the main control unit 101 may alert the user on a screen showing the result of the execution of the job, or may output data indicating the alert to a log file.

### 4. Second Practical Example

In a second practical example, too, the image processing circuit 108 analyzes input image data and extracts thin line feature amounts. The image processing circuit 108 stores feature amount data 123 indicating the extracted thin line feature amounts into the memory 103. The CPU 102 determines whether a toner image satisfies the alert conditions on the basis of this feature amount data 123, and alerts the user in accordance with the result of this determination.

In the second embodiment, furthermore, the user can issue an instruction for correcting image data for compensating for a shortage of thin line feature amounts. That is to say, in a case where it has been determined that the thin line feature amounts obtained from the image data satisfy at least one alert condition (are smaller than the corresponding thresholds), the CPU 102 corrects the image data so that a shortage of thin line feature amounts is compensated for in accordance with a user setting. Then, the CPU 102 controls the image-forming unit 20 so as to form a toner image on the basis of the corrected image data.

Correction of image data according to the present practical example may include one or both of thickening a thin line within the image, and increasing the density of a thin line within the image. The thickening and increasing in the density may be achieved using any known method, such as those described in Japanese Patent Laid-Open No. 2016-167777 and Japanese Patent Laid-Open No. 2019-139083, for example.

The thickening may be achieved by, for example, changing a line width of a line object, or a character size of a character object, described in PDL data prior to rasterization 111. Alternatively, the thickening may be achieved by rewriting pixel values of neighboring pixels that neighbor a thin line region after rasterization 111. The increase in the density can typically be achieved prior to gamma correction 116.

Japanese Patent Laid-Open No. 2017-156723 discloses a method in which a dither matrix that does not easily cause disconnection of a thin line is used for halftoning with respect to pixels that belong to a thin line region. Japanese Patent Laid-Open No. 2019-139083 discloses a method in which a line width in a toner image is enlarged or reduced by variably controlling the range of light emission of laser light.

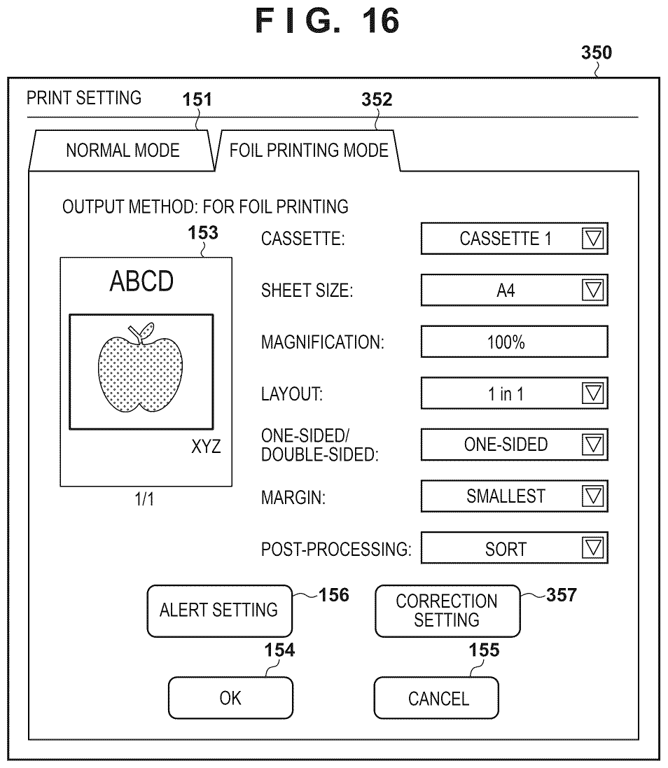

FIG. 16 shows an example of a configuration of a print setting screen 350 according to the second practical example. The print setting screen 350 includes a normal mode tab 151 and a foil printing mode tab 352. In a case where the user is planning to print a foil on a sheet by using toner of a toner image as an adhesive, the user selects the foil printing mode tab 352.

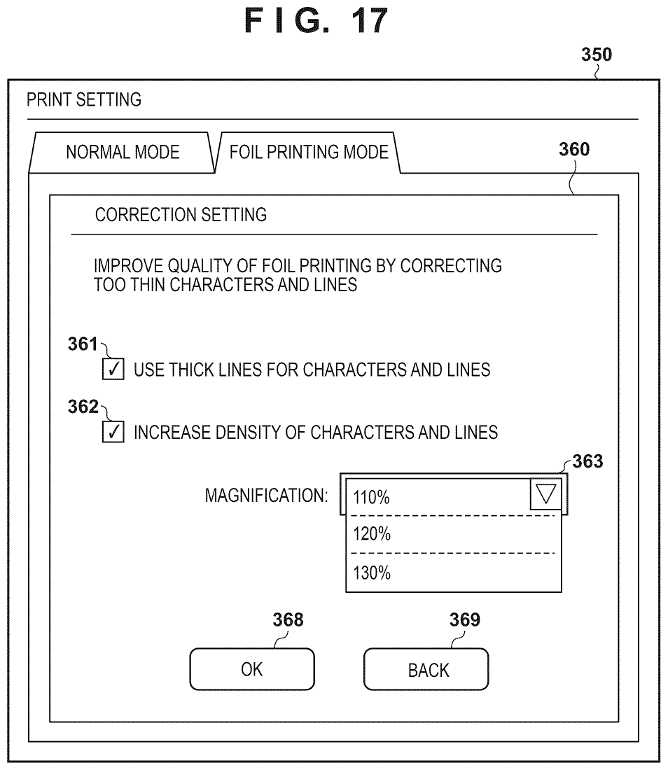

Referring to FIG. 16, the foil printing mode tab 352 includes a correction setting button 357 in addition to screen elements similar to those on the foil printing mode tab 152 according to the first practical example. When the user has operated the correction setting button 357, the CPU 102 causes the display to display a correction setting screen 360 shown in FIG. 17.

FIG. 17 shows an example of a configuration of the correction setting screen 360 according to the second practical example. The correction setting screen 360 includes checkboxes 361 and 362, a pull-down menu 363, an OK button 368, and a back button 369. The checkbox 361 is an object for causing the user to set whether to thicken characters and lines. The checkbox 362 is an object for causing the user to set whether to increase the density of characters and lines. In a case where the user wishes to thicken characters and lines, the user switches the checkbox 361 ON. Also, in a case where the user wishes to increase the density of characters and lines, the user switches the checkbox 362 ON. When the checkboxes 361 and 362 are both OFF, image data is not corrected. The pull-down menu 363 is an object for causing the user to select a magnification of the increase in the density.

When the user has operated the OK button 368, the CPU 102 obtains the setting contents changed on the correction setting screen 360, and stores them into the memory 103 or the storage 104. When the user has operated the back button 369, the CPU 102 discards the change of settings on the correction setting screen 360, closes the correction setting screen 360, and displays the print setting screen 350 again.

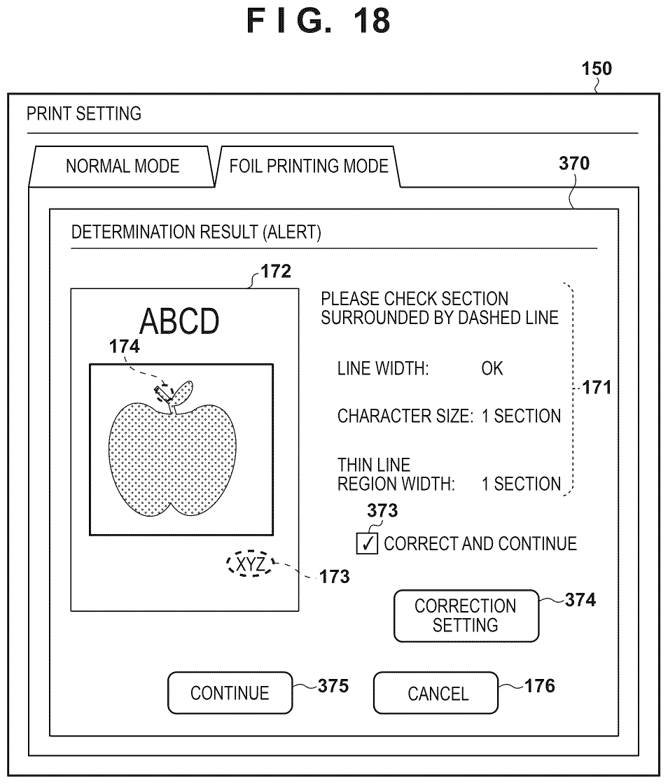

FIG. 18 shows an example of a configuration of an alert screen 370 according to the second practical example. The alert screen 370 includes a determination result field 171, a preview window 172, a checkbox 373, a correction setting button 374, a continue button 375, and a cancel button 176. The checkbox 373 is an object for causing the user to set whether to continue a job after correcting the image data in accordance with the aforementioned settings. The correction setting button 374 is a button for calling up the correction setting screen 360 described using FIG. 17. That is to say, the user can change settings related to correction of the image data upon receiving an alert in connection with a shortage of line width. For example, when the user has operated the continue button 375 after switching the checkbox 373 ON, the CPU 102 corrects the input image data in accordance with the settings accepted on the correction setting screen 360, and then starts the execution of the job in the foil printing mode.

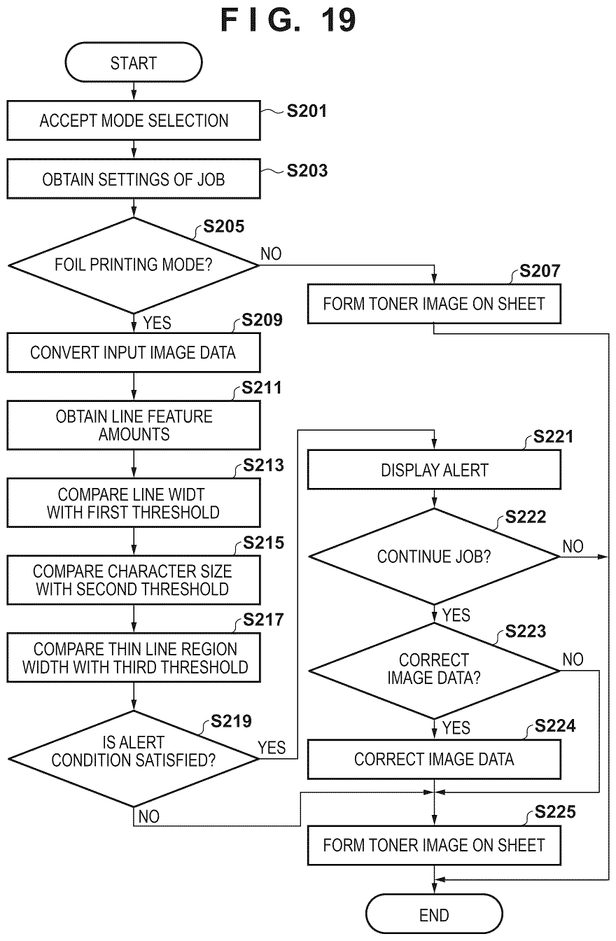

FIG. 19 is a flowchart showing an example of a flow of print control processing that can be executed by the main control unit 101 of the image-forming apparatus 100 in the present practical example. The print control processing of FIG. 19 is started in response to, for example, the user's call-up of the aforementioned print setting screen 350 via the operation unit 40 or the external apparatus 3.

First, in step S201, the main control unit 101 accepts the user's selection of an operation mode, and sets the selected operation mode on the apparatus. Next, in step S203, the main control unit 101 obtains settings of a job. For example, the main control unit 101 obtains settings related to several setting items that can be designated on the print setting screen 350. Also, in a case where the foil printing mode has been selected, the main control unit 101 obtains settings for the alert conditions that can be designated on the alert setting screen 160.

As processing of subsequent steps S205 to S217 may be similar to processing of steps S105 to S117 described using FIG. 14, descriptions thereof are omitted here.

In step S219, based on the result of comparison with the thresholds in steps S213 to S217, the main control unit 101 determines whether a toner image satisfies at least one alert condition. In a case where at least one alert condition is satisfied, processing proceeds to step S221. In a case where no alert condition is satisfied, processing proceeds to step S225.

In step S221, the main control unit 101 causes the display to display the aforementioned alert screen 370. Next, in step S222, the main control unit 101 accepts a user input representing an instruction on whether to continue the job on the alert screen 370. In a case where an instruction for continuing the job has been issued, processing proceeds to step S223. On the other hand, in a case where an instruction for stopping the job has been issued, the print control processing of FIG. 19 is ended without forming the toner image on a sheet.

In step S223, the main control unit 101 determines whether a setting for correcting the image data when continuing the job has been configured. In a case where the setting for correcting the image data has been configured, processing proceeds to step S224. In step S224, in accordance with the settings accepted on the correction setting screen 360, the main control unit 101 corrects the image data to be output to the image-forming unit 20. In a case where the setting for correcting the image data has not been configured, step S224 is skipped.

Next, in step S225, the main control unit 101 controls the conveyance unit 10, the image-forming unit 20, and the fixing unit 30 so as to form the toner image on a sheet in the foil printing mode. The sheet on which the toner image has been formed is discharged from the image-forming apparatus 100 after passing through the fixing unit 30. When the user has input this sheet to the foil printing apparatus 200, the foil printing apparatus 200 prints a foil on the sheet by using toner of the toner image as an adhesive.

### 5. Summary

Using FIG. 1 to FIG. 19, the foregoing has described embodiments of the technology according to the present disclosure, and various practical examples and modification examples related thereto. In the above-described embodiments, in a case where it has been determined that an alert condition related to a shape of a toner image are satisfied on an image-forming apparatus that forms the toner image on a sheet on the basis of image data, the display unit displays an alert. According to this configuration, it is possible to prevent a user from inputting, to a foil printing apparatus, a sheet that has a risk of producing a low-quality foil image due to a shortage of line width, thereby preventing a low-quality foil image from being formed so that a waste of a foil can be avoided.

Furthermore, in the above-described embodiments, before the image-forming apparatus forms a toner image, whether the toner image satisfies an alert condition may be determined by way of analysis on image data. Therefore, before a toner image that has a risk of producing a low-quality foil image is formed on a sheet, the user can stop the execution of a job and modify image data. In this way, a waste of sheets and toner can also be avoided.

Furthermore, in the above-described embodiments, in a case where the foil printing mode for forming a toner image to glue a foil onto a sheet via the toner image has been set, whether the toner image satisfies alert conditions may be determined, and an alert may be displayed in accordance with the result of this determination. Therefore, at the time of the execution of a normal job in which foil printing is not expected, the determination about alert conditions and display of the alert are not performed, and thus the user is not troubled by an unnecessary alert.

Furthermore, in the above-described embodiments, the alert condition is a condition related to a thin line for a case where toner is used as an adhesive. Especially, the condition related to a thin line may be a condition based on comparison between a feature amount of image data influencing a width of a thin line and a threshold. For example, by determining whether a feature amount that has positive correlation with a width of a thin line is smaller than a threshold, such defects as irregularity, disconnection, protrusion, or breakage of the thin line can be appropriately predicted, and an alert can be output. Also, the aforementioned feature amount can easily be obtained by extracting attributes of objects from image data described in a page description language format. In addition, a shortage of line width can be captured with high accuracy by detecting a thin line region in an image of a bitmap format and determining a width of the thin line region.

Furthermore, in certain embodiments, in a case where the aforementioned feature amount is smaller than the threshold, a toner image can be formed on a sheet on the basis of image data that has been corrected so as to compensate for a shortage of line width. According to this configuration, a toner image in which the shortage of line width has been resolved can be immediately formed without the user having to suspend a job and modify the image data. In this way, the user's workload is reduced, and the productivity in production of deliverables can be improved.

### 6. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent configurations and functions.

This application claims the benefit of priority from Japanese Patent Application No. 2024-060399, filed on Apr. 3, 2024 which is hereby incorporated by reference herein in its entirety.

What is claimed is:

1. An image-forming apparatus comprising:
an image-forming unit configured to form a toner image on a sheet based on image data;
a setting unit configured to set a first mode to form the toner image for gluing a foil onto the sheet via the toner image; and
a control unit configured to control a display unit to display an alert depending on a shape of the toner image to be formed by the image-forming unit in a case where the first mode is set by the setting unit.

2. The image-forming apparatus according to claim 1, wherein
the setting unit is configured to set the first mode in a case where the first mode is selected by a user from among a plurality of operation modes related to formation of the toner image.

3. The image-forming apparatus according to claim 1, wherein
in a case where the first mode is set by the setting unit, the control unit is configured to control the display unit to display the alert when it is determined that the toner image satisfies an alert condition related to a thin line.

4. The image-forming apparatus according to claim 3, wherein
the control unit is configured to determine whether the toner image satisfies the alert condition by analyzing the image data before the image-forming unit forms the toner image.

5. The image-forming apparatus according to claim 4, wherein
in a case where a specific part of the toner image satisfies the alert condition, the control unit is configured to control the display unit to display a preview of the toner image in a mode that allows the specific part to be distinguished.

6. The image-forming apparatus according to claim 3, wherein
the alert condition includes a condition that a feature amount of the image data influencing a width of a thin line is smaller than a threshold.

7. The image-forming apparatus according to claim 6, wherein
the control unit is configured to obtain the feature amount by extracting an attribute of a constituent element of an image from the image data described in a page description language format.

8. The image-forming apparatus according to claim 7, wherein
the feature amount includes a size of a character within the image.

9. The image-forming apparatus according to claim 7, wherein
the feature amount includes a width of a line within the image.

10. The image-forming apparatus according to claim 6, wherein
the control unit is configured to obtain the feature amount by determining a number of pixels aligned in a thin line region in a width direction thereof, the thin line region being within the image and being represented in a bitmap format.

11. The image-forming apparatus according to claim 6, wherein
the threshold is settable by a user.

12. The image-forming apparatus according to claim 6, wherein
the control unit is configured to
in a case where the feature amount is smaller than the threshold, correct the image data so as to compensate for a shortage of the feature amount, and
cause the image-forming unit to form a toner image based on the corrected image data.

13. The image-forming apparatus according to claim 12, wherein
the control unit is configured to correct the image data by thickening a thin line within an image, or increasing a density of the thin line within the image.

14. The image-forming apparatus according to claim 1, wherein
the setting unit is configured to set
the first mode or
a second mode in which the foil is not expected to be glued onto the sheet via the toner image formed by the image-forming unit.

15. The image-forming apparatus according to claim 14, wherein
in a case where the toner image formed by the image-forming unit satisfies an alert condition related to a thin line, the control unit is configured to
control the display unit to display the alert when the first mode is set by the setting unit, and
control the display unit so as not to display the alert when the second mode is set by the setting unit.

16. A foil printing system, comprising:
the image-forming apparatus according to claim 1; and
a foil printing apparatus that prints a foil image on a sheet by gluing the foil onto the sheet via the toner image.
